(19) United States
(12) Patent Application Publication
(10) Pub. No.: US 2022/0284524 A1
(43) Pub. Date: Sep. 8, 2022

(54) BLOCKCHAIN BASED REAL ESTATE REGISTRY

(71) Applicant: ARROWHEAD DEVELOPMENT COMPANY LTD., Summerstown (CA)

(72) Inventors: Irene CAMERON, Summerstown (CA); Conner CAMERON, Summerstown (CA); Karim Alexander SULTAN, Ottawa (CA); Umar RUHI, Ottawa (CA)

(21) Appl. No.: 17/619,184

(22) PCT Filed: Jun. 11, 2020
(86) PCT No.: PCT/CA2020/050797

§ 371 Date: Dec. 14, 2021

Related U.S. Application Data
(60) Provisional application No. 62/861,804, filed on Jun. 14, 2019.

(51) Int. Cl. G06Q 50/16

(52) U.S. Cl. CPC G06Q 50/163

(57) ABSTRACT

Systems and methods relating to a real estate registry and monitoring system. The blockchain based registry maintains records on each individual property within the jurisdiction that the real estate registry and monitoring system operates. The system will record changes to the property thereby creating a chronological record of a property's evolution. The blockchain based registry only adds new data records after the new data records have been vetted and approved by specific stakeholder users. These new data records are only added once a consensus from the specific stakeholder users has been received. Data records are added whenever a change that affects the property occurs, such as a sale of the property or a court order or the taking out of a building permit. Whenever new data records are added to the blockchain, all stakeholder users are notified of the change recorded. Each data record may contain a link that points to one or more supporting documentation for the change evidenced by the data record.

### TECHNICAL FIELD

The present invention relates to registration systems. More specifically, the present invention is concerned with systems and methods relating to a blockchain based real estate registration system and monitoring system.

### BACKGROUND

The data processing revolution that has been on-going for the past few decades has led to numerous enhancements to our daily lives. Data processing and digitization now permeates most aspects of our lives. Sadly, the same cannot be said for record keeping and document storage when it comes to real estate. The entry of changes in real estate records are, in some jurisdictions, still being done manually. Clerks are still manually entering changes to paper real estate records for some of these jurisdictions. Where digitization has occurred, clerks are still required to retrieve electronic records whenever the status of a real estate property is required.

In addition to the above, current systems are not integrated in that a detailed history of a real estate property is not easily retrievable. As well, changes in the status of a real estate property are not readily available without lengthy visits to a property office or to the local government house. One issue with this is that lenders (such as banks and mortgage companies) need to have staff dedicated to title searches and other registration related searches. Another issue is that other stakeholders who have an interest in the real estate property may not be aware of changes being made to the property or registered against that property. As an example, an insurance company that insures a property may be interested in knowing that a building permit has been issued for that property. Such a building permit may show a need to change the insurance coverage or may, at the very least, show a need to re-examine the policy.

It should also be clear that current systems are sadly lacking when it comes to the amount of information available. Unless a potential buyer allocates a lot of resources to finding the true history of a property, there might not be a simple and easy way to determine what building permits, work orders, court orders, liens, bankruptcies change of insurance underwriters, insurance claims, etc., etc. are associated with a specific property. Because of this lack of information, in many cases buyers are left with large gaps of knowledge as to a property's true history. The buyer can, of course, query the seller about the history of the property (e.g. does the property have a history of flooding? Was a building permit taken out when a major renovation was done? Has there ever been a fire on the premises?) but the seller may only know of the property's history while it was under the current seller's purview. The history of the property prior to the current owner may not be available. Such knowledge, of course, may affect decisions such as whether the buyer wants to purchase the property, how much insurance to get for the property, etc., etc. As well, the current system relies significantly on the candor, honesty, and trustworthiness of the current seller to provide the property's history.

The current state of affairs thus tends to slow down the pace of real estate-based transactions and decreases trust and confidence in the registration system as registrations and changes affecting the property are not fully integrated in one place and can easily be missed.

There is therefore a need for systems and methods that address the issues noted above. In addition, such systems and methods should be easy to use and should promote integrity and trust in the system.

### SUMMARY

The present invention provides systems and methods relating to a real estate registry and monitoring system. The blockchain based registry maintains records on each individual property within the jurisdiction that the real estate registry and monitoring system operates. The system will record changes to the property thereby creating a chronological record of a property's evolution. The blockchain based registry only adds new data records after the new data records have been vetted and approved by specific stakeholder users. These new data records are only added once a consensus from the specific stakeholder users has been received. Data records are added whenever an event that affects the property occurs, such as a sale of the property or a court order or the taking out of a building permit. Whenever new data records are added to the blockchain, all stakeholder users are notified based on the nature of the change recorded. Each data record may contain a link that points to one or more supporting documentation for the change evidenced by the data record.

In one aspect, the present invention provides a system for managing data relating to a plurality of real estate properties, the system comprising:
a data block management module for managing data records stored in distributed databases using a blockchain data structure, each of said data records relating to a specific one of said plurality of real estate properties;
a document management module for managing storage and retrieval of documents, each of said documents relating to one or more of said plurality of real estate properties;
a consensus management module for receiving input from a plurality of users and for determining if a projected data record detailing a change affecting said specific one of said plurality of real estate properties is to be created;
a notification management module for managing notifications to at least a subset of said plurality of users, wherein
specific data records relating to a specific one of said plurality of real estate properties are uniquely marked such that data records relating to said specific one of said plurality of real estate properties are retrievable from said distributed databases;
said projected data record is created only after approval from specific users has been received, wherein different changes to said specific one of said plurality of real estate properties is detailed by different records and approval from different specific users is required before different records are created; and
whenever a projected data record is created, at least one notification is automatically sent to all stakeholder users by way of said notification management module.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention.

### DETAILED DESCRIPTION

The present invention relates to systems and methods for a blockchain based real estate property registration and monitoring system. The system operates by creating a block or record for each change or registration relating to a specific piece of real estate (i.e. a real estate property) and this block or record will contain a unique identifier specific to that piece of property and this unique identifier will be on all records that relate to that specific real estate property. The block or record is, in keeping with the blockchain structure, stored on multiple servers and are mirrored by other servers. Thus, any change or event affecting the property that requires registration is reflected by a new block or new record. As examples, a building permit, a mortgage, and a lien would all require registration and would each generate a new block or a new record. However, unlike other blockchain systems, the present invention allows for documents to be associated with each record or block. These documents, identified in the relevant record, are stored in one or more servers and can be accessed by way of a link in the record.

It should be clear that the term “stakeholder user” refers to those other than a “custodial user”, a “professional user” and a generic “user” of the system. A “stakeholder user” refers to individuals, institutions, organizations, or any entity that has a stake, interest, position of influence, fiduciary duty, legal duty, or contractual obligation regarding a specific property. In addition, a stakeholder user is one who can affect the records concerning that specific property within the system. Thus, without limiting the definition, a “stakeholder user” includes the owner of the property, mortgage companies or other lending institutions that may hold a mortgage or a financial interest in the property, insurance companies that may hold a policy affecting any and all real or personal property within or affected by the property, a lien holder, a guarantor of debt secured by the property, an easement holder, the governing conservation authority, the governing environmental protection agency, and an entity that warranties the property. Of course, “stakeholder user” also includes a municipality or local government organization that has a duty to govern over the specific property and to keep and/or maintain records concerning the specific property. It should also be clear that organizations, associations, or any other group composed of or representing these stakeholder user entities may also be stakeholder users.

A “custodial user” is one who can affect the records concerning that specific property within the system when they are acting on behalf of a “stakeholder user”. A custodial user includes but is not limited to lawyers, notaries, or other legal representatives who have a duty or contractual obligation to represent one or more entities in one or more transactions affecting the specific property and are able to consent to changes to a specific property on behalf of their stakeholder client only as long a contractual obligation exists with the individual or entity that they represent who holds a direct stake, interest, or position of influence in a specific property and their actions are governed by the party that contracted them and to whom they hold a fiduciary duty.

Another class of users that will have limited access to view information regarding registered properties but not have the ability to make changes to any specific property or properties are “professional users”. Professional users are real estate professionals, lawyers, notaries, appraisers, surveyors, and any other group that is composed of or representing a group whose profession deals with real property. The professional users must be members of a professional association that have an official code of conduct and an oversight body to monitor the professionals within their organization. The level of detail and the scope of information accessible to professional users regarding any one specific property would be limited by the privacy laws in the governing jurisdiction.

In addition to the above, the system operates by ensuring that any new records that reflect changes affecting the property are only created after specific stakeholder users have approved these changes. Of course, different changes would mean that different users (for example, users whose interests in the property may be affected by the changes) would need to approve the records for those changes. As an example, a record that details and evidences the sale of the property would need to be approved by the lawyer/notary/legal professional representing the current owner of the property, and the lawyer/notary/legal professional representing the buyer in the transaction. Similarly, a record evidencing a mortgage registered against the property would need to be approved by the lawyer/notary/legal professional representing the owner of the property, the lawyer/notary/legal professional representing the bank or lending institution registering mortgage, and any other lawyers/notaries/legal professionals involved in the transaction. The system operates by only creating the necessary record or records after the necessary stakeholder users have approved of the record/records. For some implementations, all the necessary stakeholder users have to approve the record (unanimity amongst the relevant users) while in others, approval of only a majority or some other predefined subset of relevant stakeholder users is necessary. Thus, as an example for one implementation, for a building permit record to be recorded against a property, the relevant stakeholder users (i.e., the property owner and the municipality issuing the permit) would all need to approve the building permit record before the record generates a transaction to the blockchain which is then committed to a block in the blockchain. For some implementations, multiple series of interconnected events are executed in parallel after being triggered by one or more predecessor events, and each of these events require specific relevant stakeholder users to approve of the details of the specific data record for the individual event within the series of interconnected events, and all of the interconnected events must be approved by the specific relevant stakeholders unique to the each event prior to each event being committed as a block to the blockchain. An example of a series of interconnected events that are executed in parallel is the sale of a newly constructed home to a buyer who is registering a government guaranteed mortgage, a homeowner's insurance policy, and a new home warranty. For each event of the relevant stakeholder users, the buyer's lawyer and the lender's lawyer and the representative for the government guarantee program, the new property owner and the representative of the insurance company issuing the insurance policy, and the new property owner and the new home warranty program representative must all approve the details of the individual records specific to each individual interconnected event prior the predecessor event which is the transfer of ownership in the specific property from the seller to the buyer being able to be approved by the lawyer for the seller and the lawyer for the buyer. Once all relevant stakeholders to each event have approved of the records for their individual events, then the transfer of ownership record can be committed as a block to the blockchain, simultaneously the blocks representing the registered mortgage, the government guarantee, the property insurance registration, and the new home warranty registration can be committed as blocks to the blockchain. It should be clear that without the approval for each of the individual events in the series of parallel interconnected events, the predecessor event, in this case being the transfer of ownership, cannot be approved of or committed to the blockchain. It should be clear that each and every significant event that affects the property generates a transaction and that transaction is recorded in a block in the blockchain. Any such event is recorded in the block.

The system of the present invention also has the additional feature of notifying all of the registered stakeholder users for a property whenever a change in the property is recorded. As an example, whenever a building permit has been issued against a property, a notification is automatically sent out to the institution holding the mortgage and to the insurance company insuring the property as well as the owner and the municipal government and all other registered stakeholders for that specific property. The building permit notification can alert the institution holding the mortgage to determine if changes to the property need to be taken into account for the mortgage. The insurance company insuring the property may, based on the notification, revisit the insurance coverage for the property to see if additional coverage is required. Similarly, if a second mortgage is registered against the property, the institution holding the first mortgage would be notified.

It should be clear that, in addition to only committing record changes after a consensus from specific users/stakeholders have been received, the system also uses the concept of custodians. Custodians or custodial users are users who are impartial and whose approval is necessary before specific records evidencing specific changes affecting the property are committed to the blockchain. As an example, the sale of the property would require approval from the two lawyers/legal representatives involved in the property sale with the lawyers/legal representatives being the custodians for the current owner and the buyer and also being users of the system. To ensure trust in the system, it is preferred that the custodian users be licensed law practitioners or be a member/part of a trusted profession. In this implementation, there are two custodians for every property sale and each custodian is a lawyer who acts for the seller or for the buyer of the property. As noted above, to approve of the record evidencing the property sale, the custodian acting for the property owner, and the custodian acting for the property purchaser have to approve the record. The custodians ensure the stakeholder's interests are protected, and rules enforced. The custodians ensure that, from the government's side, the necessary paperwork, taxes, and other details have been dealt with and approved. Of course, while the system uses the concept of custodians, these custodians are not necessary for the system to operate properly. The use of custodians may be implementation specific and may be dependent on the governing laws of the jurisdiction for which the system is used.

For better clarity, it should be noted that, in keeping with the blockchain structure used in the system of the present invention, each record stored in the blockchain is immutable and unchangeable. Thus, any changes affecting the property would need to be evidenced by a new record detailing that change. Thus, a sale of the property and an identification of the new owner would be in one record. Similarly, a mortgage on that property would need a new record and a discharge of that mortgage would require another new record. Similarly, it should be clear that the stakeholder users whose approval for the changes to be recorded against the property would change depending on that change. Thus, to record a mortgage against the property, the owner, the lender, and at least one custodian would need to be involved. All of these users would need to approve the record detailing the mortgage before that record is committed to the blockchain. Similarly, to record a discharge of a mortgage, the lender, the owner, and at least one custodian would, again, need to be involved. All of these users would need to approve the record for the discharge before the record is committed to the blockchain. To register an insurance policy against the property, the insurer, the property owner, and possibly one custodian would need to be involved and would need to unanimously approve of the record to be registered. Changes in insurer or in the insurance policy (such as changing from one insurer to another or upgrading the insurance coverage) would need the insurer and the property owner, and, depending on the configuration, possibly one custodian. For insurer changes, depending on the implementation, the previous insurer and the new insurer may need to both be involved. IT should be clear that the necessity for the involvement of a custodian would be implementation specific and would depend on whether one or more parties to the change wish to have a lawyer/custodian involved, or whether a lawyer/custodian is required to facilitate the change.

Note, however, that there are instances when even the owner of the property is not required to assent to the recording of a change affecting the property. Examples of these would be the registering of a lien against the property, the registering of a court order against the property (e.g. a court order in the case of a default against a mortgage), or a court or local/provincial/federal authority ordering a sale of the property. In these instances, the municipal/local authority may need to provide approval and a suitable custodian may also be required to provide approval. In another implementation, a custodian user, authorized by the court handing down the court order, may be the only user necessary to record the court order or lien on the property. Note, however, that the property owner would not be required to provide approval for the recordation in these cases.

To record the removal/discharge of these liens and court orders, once the debts have been settled, then, again, a court appointed custodian user can approve, single-handedly, the recordation of the cancellation or removal of these liens and/or court orders. In the case of a court ordered sale of the property, the sale can be evidenced by a record that has been approved by the court appointed custodian along with possibly the custodian for the purchaser. For a court ordered sale of the property, the owner of the property is not required (and will not be polled for) to approve the recordation of the sale record.

It should also be clear that supporting documents for the records added to the blockchain can be referenced in the records. As noted above, these documents, preferably in PDF format, are stored in one or more servers and can be accessed by way of the link to the documents in the record that will be paywall blocked. The servers storing these documents can have redundancy and mirroring protection to ensure that the documents are safe and are always available for retrieval. For each supporting document, a hash code is generated and recorded on the Blockchain. This hash code changes radically if even a single byte of the original document is altered. In this way, the system can prove that the supporting document being referenced is the original supporting document (by generating a hash code for the suspect document and comparing it to the recorded, immutable version. This allows for proof of existence at the time of recording. If a stakeholder later challenges the authenticity of, for example, a lien document, the hash code comparison will prove authenticity, 256-bit (32 byte) hashes are generated using the SHA256 Hash Algorithm (NIST SHA-2 Family). Hash codes are unique “fingerprints” used for cryptographic purposes. As examples of supporting documents that can be referred to in the records or blocks, a copy of the Agreement of Purchase and Sale can be referenced in the record evidencing the sale of a property. Similarly, a court order ordering a power of sale for a property can also be referenced in a record detailing the sale of the property. For a lien, a copy of the registered lien (issued by the court or by a suitable authority) can be referenced in the record detailing the lien on the property. For insurance coverage, a copy of the insurance document many not be necessary but a copy of evidence of the insurance (e.g. an insurance card noting the property details, the insurer, and the property owner) may be stored. For a new home warranty, a copy of a warranty document can be referenced in the record detailing the warranty on the property.

In terms of access to the system, the stakeholder users whose approval is necessary to commit records to the blockchain are, of course, allowed into the system. However, to ensure wide acceptance and transparency, the general public should have viewing privileges for the various records. Of course, common security protocols may need to be followed such as registering for an account with the system before being allowed to view and/or search the system. User accounts, depending on the identity of the user, may have different access privileges to different records for different properties. Depending on the configuration of the system, the ownership and/or general history of a property may be viewable by the general public, possibly for a fee, but more involved records, including insurance records, may be restricted to specific users or specific classes of users (e.g. only restricted to owners, custodians, insurance companies, government users, etc., etc.). Thus, a user from the general public should be able to access a property's history such as who has owned the property, who has purchased the property, have there been any liens on the property, and if mortgages applied against the property have been discharged or not. It should, however, be clear that general public access to the various types of information noted above may be implementation specific and may be dependent on any and all privacy laws governing in the jurisdiction for which the system is used. Similarly, general public access to various types of information listed above may be dependent on the privacy laws governing in the jurisdiction in which the property is located.

For ease of access to the various records in the blockchain, each record relating to a specific property can be tagged with a unique tag or number. This allows all records for that property to be easily retrieved by simply scanning the blockchain and retrieving the blocks or records with that specific unique tag or number. As well, for ease of viewing a property's history, a summary of each record added for that property can be appended to a summary file specific to that property. That summary file can then be easily provided to a user who wishes to access that property's history. For privacy, not all changes may be recorded in this summary file such that only major changes (e.g. liens, court orders, sale, etc.) are reflected in the summary file. It should be clear that the summary file is not stored in the blockchain but is, rather, simply a shortcut for ease of accessing a property's history. If the summary file is not used, a user would need to instruct the system to perform a search on the blockchain for records specifically pertaining to a specific property. If the summary file is used, the system can simply retrieve the summary file for a specific property whenever a user initiates a search for that specific property's history.

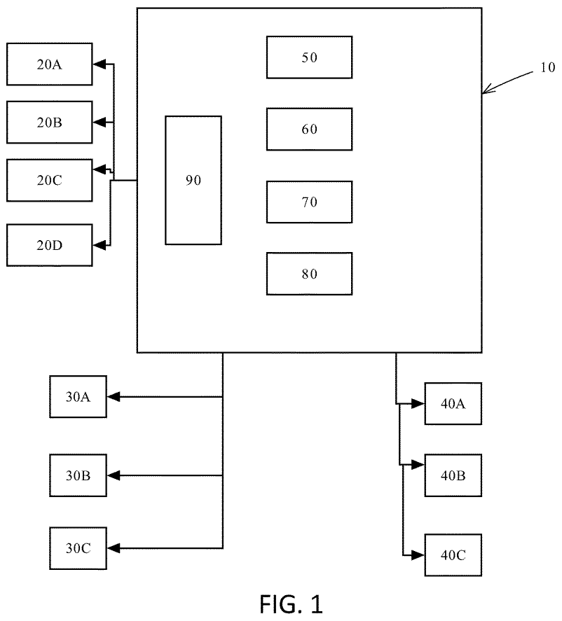

Referring to FIG. 1, a block diagram of a system according to one aspect of the invention is illustrated. As can be seen, a system 10 includes a number of internal modules which can be a combination of both software and hardware. The system itself is also a combination of both software and hardware and operates to implement the real estate registry and tracking system as outlined above. From FIG. 1, the system 10 communicates with a number of users 20A, 20B, 20C, 20D by way of network communication links. The system 10 also communicates with document databases 30A, 30B, 30C, with the document databases storing supporting documentations relating to the data records being stored in the above noted blockchain structure. The system 10 also communicates with blockchain storage servers 40A, 40B, 40C. Each of blockchain storage servers 40A, 40B, 40C stores copies of each other's databases and the blockchain is maintained by these servers. To add a data record for storage in the blockchain, the server 10 creates the data record and propagates that data record through the various servers 40A, 40B, 40C and these servers follow conventional blockchain protocols to ensure that the exact same data record is being stored in all of the servers. This mirroring ensures that each data record stored in the blockchain is immutable and cannot be altered or removed. Queries to the system 10 are sent by the users and responses to the queries are provided by the system 10. In addition, specific users may seek to add data records to the blockchain. These data records are created by the system, and once approval has been obtained, these are then sent for propagation through the servers 40A, 40B, 40C. Any accompanying documentation for these data records are stored in the databases 30A, 30B, 30C.

Within the system 10 are the above noted internal modules. These modules include: a data block management module 50, a document management module 60, a user consensus module 70, an access module 80 and a notification module 90. These are functional modules and are meant to encapsulate the functions of potentially many actual software/hardware modules in the system. The functions of these modules are described below. The data block management module 50 manages the creation and addition of new data records to the blockchain. As noted above, new data records relating to changes affecting a specific real estate property can be created and added to the blockchain as unchangeable and permanent records. A specific user creates or causes the creation of a new data record for a specific property and this new data record is then vetted or reviewed by specific users. This set of specific users performing the review may be different depending on the nature of the new data record. Once a consensus (e.g. a unanimous approval or, depending on the implementation, a majority of specific user approving the new data record) has been reached among the specific users, the data block management module receives the approval for the new data record. The new data record is then processed and sent to the servers 40A, 40B, 40C for addition to the blockchain. The data block management module 50 thus manages the placement, creation, and tracking of the various data records in the blockchain.

It should be clear that, given the various types of transactions and documents that can be added, the data block management module may be designed to include rules and limitations for each possible type of transaction and/or document that might be encountered. The workflow of the system thus follows these rules and is, as can be imagined, document and/or transaction dependent. Thus, the rules as to who to notify, whose approval is required, what level of consensus is required, etc. for each possible type of transaction and/or document is stored in the data block management module. Once a transaction type or a document type has been determined, the rules for such a transaction/document are retrieved and/or followed.

The document management module 60 manages the supporting documents noted in various data records. As mentioned above, when creating data records for addition to the blockchain, users can attach supporting documentation. In one example, a data record for a sale of the property can have, as an associated document, the Agreement of Purchase and Sale for that transaction. Similarly, when creating a data record for a court ordered sale of the property, a custodian user can attach a copy of the court order itself. These supporting documents can be referred to in the data record as a link to the server storing the documents. Thus, a user accessing the data record can merely click on the link for the supporting document to have the document retrieved and presented to the user. The storage of these documents and the management of the servers storing these documents are dealt with by the document management module 60. Preferably, the documents are in a format (e.g. PDF format) that is well-known and easily viewable.

The user consensus module 70 deals with the details of contacting specific stakeholder users and requesting approval from these specific stakeholder users regarding the addition of specific data records to the blockchain. As noted above, new data records, prior to being added to the blockchain, will need to be vetted/approved by specific stakeholder users who may have an interest in the change evidenced by the new data record. Thus, for a new data record detailing a sale of the property, the custodial users acting on behalf of the buyer, and the seller, being their respective lawyers will need to approve of the new data record. The user consensus module 70 thus sends out communications to these specific stakeholder users or, as in this case, to the custodial users acting on behalf of the stakeholder users and asks for their approval for the new data record. These communications can take the form of emails with links to the proposed data record or they can take the form of notifications to the stakeholder users that their approval is needed. The stakeholder user can then log into the system and then review and approve of the proposed data record. Once the user consensus module 70 has received approval for the new data record (e.g. by receiving a unanimous approval from all of the specific users), then an indication of the approval is sent to the data block management module 50. This indication, once received, allows the data block management module 50 to process and add the new data record to the blockchain. It should, however, be clear that, depending on the implementation, a unanimous approval may not be necessary before specific new data records are added to the blockchain. For significant changes to, for example, the ownership of the property, unanimity is required from the impacted stakeholders (including owner, buyer, lender, and insurer) due to the significance of the changes custodians will consent on behalf of the owner, the buyer, and the lenders. The custodians must ensure changes are in compliance with contractual agreements and jurisdictional law, and must obtain current and new secured lender consent when borrowing is involved, current and new insurer consent for insurance coverage, etc., etc. However, for less onerous changes affecting the property, such as the registering of a building permit, approval from the owner and the municipal authority may suffice. As noted above, the rules for what kind of consensus may be required or whose approval may be required would be transaction/document dependent and these rules, and the workflow resulting from the rules, are detailed in the data block management module.

The access module 80 determines the level of access users have to the system and which users are even allowed (or not allowed) into the system and into specific data records. As an example, a user wishing to view minimal data for a specific property (e.g. owner name, location of the property) may simply need to register with the system for an account. Other users who need more access may require higher level access, such as the ability to be able to receive notifications if specific changes are registered against a property and may need to register for this higher access. To this end, subscription fees may need to be applied against this higher-level user and the identity of the user may need to be verified independently of the system. This verification may be more important as the identity of trusted users (such as custodian users and representatives of municipal authorities) will need to be scrupulously verified. In addition, access to the more involved transactions of the system (such as the creation of new data records detailing, for example, a sale of a property) may be restricted to identity verified users, especially property owners. Thus, the access module 80, after a user logs in, determines the user's level of access to not just the system as a whole but to specific data records for specific properties. As an example, a user A may own property A1 but not property B1. Thus, user A would be allowed almost unfettered access to data records relating to property A1 but is not allowed detailed access to records for property B1. As well, user A is allowed to perform general searches for other properties similar to the general public but, for specific access to, for example, changes in insurer for property B1, user A is not allowed. As well, subject to privacy laws of the governing jurisdiction, A may not have access to know who the insurer is for property B1 As can be imagined, as the owner of property A1, user A can create new data records affecting property A1 (with the new data records being subject to approval from other specific users such as banks, insurers, municipal government etc.) but cannot create new data records affecting property B1. The level of detailed access that a general user has to property records may be dependent on implementation and will depend on the privacy laws of the jurisdiction that implements the system. As is known, in some jurisdictions, the general public has detailed access to property records including all records of changes affecting property. However, in other jurisdictions, the general public may only access the bare minimum of data regarding specific properties. As can be imagined, suitable safeguards that protect privacy are built into the system and would underlie the access controls to the various parts of the system as a whole.

It should, of course, be clear that, depending on the level of access needed and the identity of the user or of the institution represented by that user, access may be granted by the module 80 to specific records. As an example, a user representing a lending institution (e.g. a bank or a mortgage lender) would need higher access to the system as this user would need to check on the accuracy of data provided by, for example, a property owner. For such users, the module 80 may provide stakeholder access so that the user can view and review data records affecting properties. For specific properties, such a user would have the ability to create and put forward new data records for approval to be included in the blockchain. Such an ability is necessary as the bank/lending institution may need to register data records detailing the discharge of a mortgage or discharge of a lien. In addition, this stakeholder user may also need to have the ability to review and approve of specific new data records that affect its interests in the property. As an example, if a new mortgage is being registered against a property that is already being mortgaged by this specific lending institution, then this stakeholder user would need to approve of that new data record. Similarly, if someone other than the institutional stakeholder user attempts to add a new data record evidencing a discharge of a mortgage held by the institution, then the institutional stakeholder user would have the ability to be notified and to approve or reject such a new data record. For clarity, such level of access for stakeholder users or for users who require a higher level of access than the general public may be levied with subscription fees higher than the casual general user.

For clarity, a unique PIN or a Property Identification Number is assigned to each property registered in the system. The PIN is used throughout the system to uniquely track events and/or transactions affecting the specific property. Other unique property tracking systems may, of course, also be used. In one implementation, the PIN may be assigned to a property when a new property is created (e.g. if the property is subdivided) and that newly created property is to be reflected on the blockchain. For properties that already exist as of the implementation date of this system they will be registered in the system using their existing assigned PIN or identification number, and the property will be assigned to the validated owner(s) of the property. If the current registry system does not have PINs or identification numbers assigned to existing properties, then upon implementation the system will generate a new PIN for each property and the property will be assigned to the validated owner(s) of the property. Similarly, other schemes which assign a unique identification to a property in the system may be used, but once the specific property is uniquely identified with a PIN in the system, that PIN never changes.

To determine who the stakeholders are or who are the users allowed to change and/or access to a property's records, if stakeholder data is missing from the records, the owner and/or custodians of the property may be prompted for such data when relevant records are accessed. As an example, if a property owner is accessing a property's records and there is no entry for an insurance company against that property, the property owner can be prompted to enter such data. This would assist in ensuring more complete records for each property. Similarly, if an insurance company or a mortgage/lending entity registers an interest against a specific property, such a registration would require validation from the relevant stakeholders/users of the specific property. Once such interests have been registered, the system would thus have a more complete record of the stakeholders of a specific property.

With respect to how the system knows which users are allowed to create new data records for which property, logic is established within the system that determines for each action which user's permission is required to affect the action. Consensus from the specific user(s) would be required before the system makes the change and the action is recorded.

Regarding the notification module 90, this module ensures that all stakeholder users registered on a property are notified whenever specific changes are recorded against one or more specific properties. For each property in the blockchain, a list of stakeholder users to be notified is created, with each of the stakeholder users in the list being associated with one or more types of changes. When a change occurs for the property, all stakeholder users associated with that property are sent a notification. Thus, as an example, for a change relating to a building permit being issued for a property, all stakeholder users associated with the property are sent a notification. These notifications would provide general details regarding the change recorded in the new data record and would also identify the property. This way, all stakeholder users are provided with the identity of the property and the change that was recorded. The notified stakeholder users can then check to ensure that these new changes do not affect their interests in the property (e.g. the stakeholder user representing the interest of the property insurer can check to see if further insurance is needed as a result of the building permit issued on a property).

It should be clear that the notifications sent by the notification module 90 may take any electronic form. As such, emails, text messages, and other electronic communication may be used to communicate with the specific stakeholder users about the recorded change affecting the property. Depending upon the stakeholder user and their level of access regarding a specific change, they may have access to additional information once they log into the system. If the stakeholder user is eligible to access further information regarding the change, once they log into the system they may have access to a link to the data record that has caused the notification. This serves to allow the stakeholder user receiving the notification to quickly review the new data record and to thereby determine if any actions on his part are warranted.

For clarity, for each property registered in the system, a list of the stakeholder users to be notified is maintained. The stakeholder users in the list are to be notified whenever an event affecting the property is registered in the system. This list may change over time as users, institutions, and stakeholders change throughout the life of the property. Entries in this list are removed, added, and/or modified as necessary. Notifications may be sent by way of email or any other suitable means of communication. It should also be clear that these notifications may be general in nature and content. Stakeholders who have access to details regarding the event that generated the notification may log in to the system to access such details.

In one implementation of the present invention, tiers or levels are assigned to specific users and the access that users obtain is based on their level. In this implementation, the first level is for property owners. A second level is for municipality/local government users while a third level is for users who represent individuals or institutions that hold a vested interest in the property such as secured lenders, insurance providers, utility providers, governing conservation authorities, governing environmental protection agencies other easement holders, home warranty providers, and secured debt guarantors. A further level is reserved for custodian users who operate to ensure that the records are trustworthy, and records and transactions are done in accordance with the contractual agreements and in accordance to the governing laws. Thus, first level users have unfettered access to the records for one or more specific properties (i.e. the properties owned by the user). The second level users as municipality/local government users would have a very high level of access to the records in the blockchain with restrictions in place to respect the governing privacy and other laws of the jurisdiction where the property is located. However, for third level users, these may only have access to certain records for a property. These records would, of course, be those that the third level users have an interest in. As an example, if an insurance provider is providing insurance for properties A1, A2, and A3 but not to properties B1, B2, and B3, then this insurance provider would have access to the records for properties A1, A2, and A3. Of course, the level of access that third level users would have for specific properties may be implementation dependent and would be subject to privacy and other laws of the jurisdiction where the properties are located. It should be clear that, depending on the implementation, different levels of access may be provided to users depending on those user's subscription to the system. Higher or lower levels of subscription, necessitating higher or lower levels of payment, will provide more or less access to archival documents as well as to historical data regarding a property. Such payment/access details, especially relating to archival documentation and historical records, may be implementation and configuration dependent.

It should be clear that the system of the present invention may be used to register/record various events/changes affecting the property or the interests of others regarding the property. These events/changes may include:
a change in insurers for said specific one of said plurality of real estate properties;
a change in ownership of said specific one of said plurality of real estate properties;
an insurance claim relating to said specific one of said plurality of real estate properties;
a registration of the value of the approved insurance claim in addition to the name of the general contractor who will perform work and the value of their contract relating to said specific one of said plurality of real estate properties;
an issuance of a work order relating to said specific one of said plurality of real estate properties;
an issuance of a building permit relating to said specific one of said plurality of real estate properties;
a registration of an interim building permit inspection report relating to said specific one of said plurality of real estate properties;
a registration of the final building permit inspection report relating to said specific one of said plurality of real estate properties;
a court order affecting said specific one of said plurality of real estate properties;
a lien affecting said specific one of said plurality of real estate properties;
a change in a mortgage relating to said specific one of said plurality of real estate properties;
a registration of a new mortgage relating to said specific one of said plurality of real estate properties;
a sale of said specific one of said plurality of real estate properties;
a discharge of a mortgage relating to said specific one of said plurality of real estate properties;
a registration of a removal of a previously registered change that related to said specific one of said plurality of real estate properties;
a registration of a plan of subdivision and the supplemental creation of new properties each with unique PINs from that original property;
a registration of restrictive covenants that are bound to a property for example subdivision covenants dictating construction materials, fencing, etc.;
a registration of condominium documents, certificates etc., that relates to said specific one of said plurality of real estate properties;
a registration of a lease/sublease that relates to said specific one of said plurality of real estate properties;
a registration of an easement that relates to said specific one of said plurality of real estate properties for example a utility easement;
a registration of Title Insurance and the corresponding policy that relates to said specific one of said plurality of real estate properties;
an archiving of important property specific records the owner would like to maintain like building plans, construction drawings, home inspection reports, etc. that relates to said specific one of said plurality of real estate properties;
a registration of well records when a new well is installed on a property that relates to said specific one of said plurality of real estate properties;
a registration of a septic system including the septic use permits that relates to said specific one of said plurality of real estate properties;
a registration of a new home warranty that relates to said specific one of said plurality of real estate properties;
a registration of the value of work and the names of contractors who performed work on the property for any major renovation, or for any capital investment that relates to said specific one of said plurality of real estate properties for example a new roof, a new heating and cooling system, etc;
a registration of a warranty for any major renovation performed, or for any capital investment that relates to said specific one of said plurality of real estate properties for example a warranty on a new roof, a warranty on a new heating and cooling system, etc;
a registration of a guarantor for a secured debt or lien that relates to said specific one of said plurality of real estate properties for example a co-signer or governmental guarantor;
a registration of outstanding work orders that relates to said specific one of said plurality of real estate properties;
a registration of zoning violations that relates to said specific one of said plurality of real estate properties;
a registration of environmental restrictions that relates to said specific one of said plurality of real estate properties;
a registration of violations of environmental restrictions that relates to said specific one of said plurality of real estate properties;
a registration of conservational protections that relates to said specific one of said plurality of real estate properties;
a registration of a violation of conservational protections that relates to said specific one of said plurality of real estate properties;
a registration of a building permit as well as subsequent registrations of the stages of completion of the building permit right through to the final inspection report and the closing of the permit that relates to said specific one of said plurality of real estate properties;
a registration of the general contractors, the architects, designers, that are hired to perform the work relating to an issued building permit that relates to said one of said plurality of real estate properties;
a registration of a construction mortgage as well as the subsequent draws on the construction mortgage based on verified stage of completion of the construction that relates to said specific one of said plurality of real estate properties; and
a registration of the actual value of work performed by the contractors, the architects, and designers who performed the work for the various stages of construction that relates to said specific one of said plurality of real estate properties.

As noted above, the system can be used to register/record details and/or documentation for any and all events that occur to affect the property for the purposes of registration, archiving, and/or monitoring.

Further details regarding at least one implementation of the system and how the services and capabilities of the system may be monetized are provided below:
charging a fee for access to one or more supporting documentation for an event affecting the property with the supporting documentation being accessed for a report fee by a user commensurate with the user's level of access;
charging subscription fees for access to the system by members of professional organizations whose mandate is to evaluate properties and to facilitate the purchase and sale of properties (e.g. lawyers, real estate agents, real estate appraisers, and surveyors) with the level of access these users will have to the records being determined by the privacy and other laws of the jurisdiction in which the property resides;
charging fees to professional members of the above organizations before these users can gain access to the data records;
the system will be accessible by the general public but highly limited as determined by privacy and other laws of the jurisdiction in which the property resides with general public access only being granted after the individual or organization registers an account and their identity verified;
the general public will be charged a fee for access to the registry information for a specific property;
the data records for a specific property can be summarized into a report for a fee with the level of detail of the report being commensurate with the level of access of the user requesting the summary;
each data record that is added to a property is added for a transaction fee that is payable at the time the data record is added and that data record may only be added after appropriate consensus is achieved as explained above; and
the system may be configured to offer insights based upon the cumulative data compiled and this high-level data can be mined for a fee;
the system may be configured to allow specific users to have access to general high-level data that can be compiled or aggregated to offer statistical insights based upon the cumulative data. Reports can be generated to communicate the findings, as well as high-level data can be exported to users for their own interpretation. Findings can be published in reports, or provided as raw data sources for further analysis and interpretation.

It should be clear that while the above description relates to a real estate property registration and monitoring scheme and to the registration of documentation relating to one or more real estate properties, a similar system can be implemented to relate to any tangible or intangible asset registry that involves multiple actors and/or stakeholders, or to relate to any type of registry that involves multiple actors and/or stakeholders.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, embodiments may be implemented in a procedural programming language (e.g. “C”) or an object-oriented language (e.g. “C++”, “java”, “PHP”, “PYTHON” or “C #”) or in any other suitable programming language (e.g. “Go”, “Dart”, “Ada”, “Bash”, etc.). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for managing data relating to a plurality of real estate properties, the system comprising:
a data block management module for managing data records stored in distributed databases using a blockchain data structure, each of said data records relating to a specific one of said plurality of real estate properties;
a document management module for managing storage and retrieval of documents, each of said documents relating to one or more of said plurality of real estate properties;
a consensus management module for receiving input from a plurality of stakeholder users and for determining if a projected data record detailing a change affecting said specific one of said plurality of real estate properties is to be created;
a notification management module for managing notifications to said plurality of stakeholder users,
wherein
specific data records relating to a specific one of said plurality of real estate properties are uniquely marked such that data records relating to said specific one of said plurality of real estate properties are retrievable from said distributed databases;
said projected data record is created only after approval from specific stakeholder users has been received, wherein different changes to said specific one of said plurality of real estate properties is detailed by different records and approval from different specific stakeholder users is required before different records are created; and
whenever a projected data record is created, at least one notification is automatically sent to said plurality of stakeholder users by way of said notification management module.

2. The system according to claim 1, wherein specific ones of said projected data record are created only after unanimous approval from said specific stakeholder users has been received by said consensus management module.

3. The system according to claim 1, wherein said data records relates to a change regarding said specific one of said plurality of real estate properties,

4. The system according to claim 3, wherein said change is at least one of:
a change in insurers for said specific one of said plurality of real estate properties;
a change in ownership of said specific one of said plurality of real estate properties;
an insurance claim relating to said specific one of said plurality of real estate properties;
a registration of a value of an approved insurance claim in addition to the name of the general contractor who will perform work and the value of their contract relating to said specific one of said plurality of real estate properties;
an issuance of a work order relating to said specific one of said plurality of real estate properties;
an issuance of a building permit relating to said specific one of said plurality of real estate properties;
a registration of an interim building permit inspection report relating to said specific one of said plurality of real estate properties;
a registration of the final building permit inspection report relating to said specific one of said plurality of real estate properties;
a court order affecting said specific one of said plurality of real estate properties;
a lien affecting said specific one of said plurality of real estate properties;
a change in a mortgage relating to said specific one of said plurality of real estate properties;
a registration of a new mortgage relating to said specific one of said plurality of real estate properties;
a sale of said specific one of said plurality of real estate properties;
a discharge of a mortgage relating to said specific one of said plurality of real estate properties; and
a removal of a previously registered change that relates to said specific one of said plurality of real estate properties.
a registration of a plan of subdivision and the supplemental creation of new properties each with unique property identification numbers (PINs) from that original property that relates to said specific one of said plurality of real estate properties;
a registration of restrictive covenants that relates to said specific one of said plurality of real estate properties;
a registration of condominium documentation that relates to said specific one of said plurality of real estate properties;
a registration of a lease/sublease that relates to said specific one of said plurality of real estate properties;
a registration of an easement that relates to said specific one of said plurality of real estate properties;
a registration of title insurance that relates to said specific one of said plurality of real estate properties;
an archiving of property specific records by the owner that relates to said specific one of said plurality of real estate properties;
a registration of well records that relates to said specific one of said plurality of real estate properties;
a registration of a septic system that relates to said specific one of said plurality of real estate properties;
a registration of a home warranty that relates to said specific one of said plurality of real estate properties;
a registration of the value of work and the names of contractors who performed work on the property for any major renovation, or for any capital investment that relates to said specific one of said plurality of real estate properties;
a registration of a warranty of a novation on said specific one of said plurality of real estate properties;
a registration of a guarantor for a lien on said specific one of said plurality of real estate properties;
a registration of outstanding work orders affecting said specific one of said plurality of real estate properties;
a registration of zoning violations affecting said specific one of said plurality of real estate properties;
a registration of a building permit affecting said specific one of said plurality of real estate properties;
a registration of the general contractors, the architects, designers, that are hired to perform the work relating to an issued building permit that relates to said one of said plurality of real estate properties;
a registration of a construction mortgage affecting said specific one of said plurality of real estate properties; or buildings on said specific one of said plurality of real estate properties;
a registration of the actual value of work performed by the contractors, the architects, and designers who performed the work for the various stages of construction that relates to said specific one of said plurality of real estate properties.
a registration of environmental restrictions that relates to said specific one of said plurality of real estate properties;
a registration of violations of environmental restrictions that relates to said specific one of said plurality of real estate properties;
a registration of conservational protections that relates to said specific one of said plurality of real estate properties; and
a registration of a violation of conservational protections that relates to said specific one of said plurality of real estate properties.

5. The system according to claim 2, wherein said system includes at least one owner user of said specific one of said plurality of real estate properties.

6. The system according to claim 2, wherein said system includes at least one custodian user said at least one custodian user being an impartial third party relative to said specific one of said plurality of real estate properties.

7. The system according to claim 2, wherein said specific stakeholder users includes at least one municipal authority user, said municipal authority user being a representative of a municipal authority that has jurisdiction over said specific one of said plurality of real estate properties

8. The system according to claim 2, wherein said specific stakeholder users includes all users who are individuals that hold a vested interest in a property or who are representatives of organizations or institutions that hold a vested interest in said specific one of said plurality of real estate properties.

9. The system according to claim 6, wherein said custodian user is at least one of:
a lawyer or notary representing at least one of: an owner and a buyer of said specific one of said plurality of real estate properties;
a court appointed lawyer or notary; and
a legal representative of a stakeholder user involved in a property transfer or involved in the registering of a mortgage, a lien, an easement, or other registerable change.

10. The system according to claim 1, wherein data records relating to said specific one of said plurality of real estate properties are uniquely marked such that said data records are retrievable from said distributed databases.

11. The system according to claim 1, wherein said data records are viewable by said users based on a level of access said users have such that data records with more information are viewable by users with higher level access.

12. The system according to claim 11, wherein subscription fees are charged to users before said users can gain access to said data records.

13. The system according to claim 12, wherein users with higher level access are charged higher subscription fees than users with lower level access.

14. The system according to claim 10, wherein at least one of said data records contains a link to supporting documentation.

15. The system according to claim 10, wherein a transaction fee is charged at the time of registering said data record.

16. The system according to claim 14, wherein a report fee is charged at the time a report is generated that summarizes said data records or at the time retrieval of supporting documentation is made.

17. The system according to claim 16, wherein users with higher level access have access to higher detailed reports and more documents than users with lower level access.

18. The system according to claim 10, wherein specific users have access to general high-level data that can be aggregated to offer statistical insights.

19. The system according to claim 18, wherein reports are generated to communicate findings regarding said statistical insights.

20. The system according to claim 19, wherein high-level data is exportable to users to allow users to interpret said data.

21. The system according to claim 20, wherein findings are published in reports or are provided as raw data sources for further analysis and interpretation.

22. The system according to claim 18, wherein users with higher level access have access to higher detailed reports and more data than users with lower level access.

23. The system according to claim 18, wherein a report fee is charged to access the cumulative data finding reports, and a data mining fee is charged for data exporting.

24. The system according to claim 23, wherein users with higher level access are charged higher report fees and charged higher data mining fees than users with lower level access.
